(19) United States
(12) Patent Application Publication
(10) Pub. No.: US 2026/0168216 A1
(43) Pub. Date: Jun. 18, 2026

(54) OZONE SIDE SPRAYER

(71) Applicant: Kohler Co., Kohler, WI (US)

(72) Inventors: Kenneth Andrew Kapal, Sheboygan, WI (US); John Oliver Lipinski, Sheboygan, WI (US); Leo Hoplamazian, Chicago, IL (US)

(21) Appl. No.: 19/406,417

(22) Filed: Dec. 2, 2025

Related U.S. Application Data
(60) Provisional application No. 63/734,482, filed on Dec. 16, 2024.

(51) Int. Cl. E03C 1/04; C02F 1/78

(52) U.S. Cl. CPC E03C 1/04; C02F 1/78; C02F 2307/06; E03C 2001/0415; E03C 2201/40

(57) ABSTRACT

The present application relates generally to a faucet assembly with a side sprayer and ozone production assembly. An ozone production assembly may include a control circuit, an ozone generator, an injector, and a flow switch for producing and supplying ozone to a flow of non-ozonated water received from a diverter of a faucet assembly. In turn, a flow of ozonated liquid may be provided to a side sprayer of a faucet assembly for an ozone spraying operation.

### CROSS REFERENCE TO RELATED APPLICATIONS

This application claims the benefit of U.S. Provisional Application No. 63/734,482 filed on Dec. 16, 2024, the disclosure of which is hereby incorporated by reference in its entirety.

### TECHNICAL FIELD

This disclosure relates to a faucet assembly. More specifically, this disclosure relates to a faucet assembly with a side sprayer and ozone production assembly for spraying ozonated and non-ozonated fluid.

### BACKGROUND

Traditionally, a faucet and side sprayer encompass a singular pathway or channel for liquid to pass. In operation, the liquid is dispersed out of an outlet of the faucet and side sprayer, and, by itself, or in combination with cleaning solutions, are used to remove remnants, residue, or other particulates off dishes, containers, or other objects. However, dispensed liquid, either alone or in combination with a cleaning solution, often fails to adequately clean or remove bacteria and particulates from an object. This is often the case when dishes or objects include troublesome or hard to reach internal or external corners. While external tools may be used in the form of sponges, brushes, or other handheld devices to assist in the cleaning, such tools often run the risk of breaking or damaging delicate and fragile objects. Moreover, if not cleaned properly themselves, the tools may subject an object to undesirable smells and bacteria. Therefore, what is needed in the field is a faucet assembly that allows for a production of ozonated fluid capable of killing bacteria on exposed surfaces, e.g., food and utensil surfaces. Further, there is a need for converting pre-existing side sprayers into ozonated side sprayers capable of effectively spraying ozonated and non-ozonated fluid.

### SUMMARY

The present application relates generally to a faucet assembly with a side sprayer and ozone production assembly for spraying ozonated and non-ozonated fluid. In one example, an ozone production assembly may include a control unit with a control circuit, an ozone generator, an injector, and a flow switch for producing and supplying ozone to a flow of non-ozonated liquid. In turn, a flow of ozonated liquid may be provided to a side sprayer of a faucet assembly.

In another example, a faucet assembly may include a plurality of supply hoses, handles, a diverter, and a side sprayer fluidically coupled to an ozone production assembly. An ozone production assembly may include a supply hose, a control unit, a user interface device, and a coupling mechanism for supplying a flow of ozonated fluid to a side sprayer. Depending on a received user input, a control unit may selectively supply ozone to a side sprayer for carrying out an ozone spraying operation.

The foregoing is a summary and thus by necessity contains simplifications, generalizations, and omissions of detail. Consequently, those skilled in the art will appreciate that the summary is illustrative only and is not intended to be in any way limiting. Other aspects, features, and advantages of the device described herein, as defined by the claims, will become apparent in the detailed description set forth herein and taken in conjunction with the accompanying drawings.

### BRIEF DESCRIPTION OF THE DRAWINGS

FIG. 1 is a perspective view of a faucet assembly fluidically coupled to an ozone production assembly, according to an example.

FIG. 2 illustratively shows a control unit of an ozone production assembly, according to an example.

FIG. 3 illustratively shows a control circuit of an ozone production assembly, according to an example.

FIG. 4 illustratively shows an internal fluid flow path through a control unit, according to an example.

FIG. 5 illustratively shows restriction placement information for a venturi injector, according to an example.

FIG. 6 illustratively shows cross sectional area information for a venturi injector, according to an example.

FIG. 7 illustratively shows a side sprayer and a user interface device of an ozone production assembly, according to an example.

FIG. 8 illustratively shows an internal view of a user interface device, according to an example.

FIG. 9 illustratively shows a coupling mechanism of an ozone production assembly, according to an example.

While various examples are amenable to various modifications and alternative forms, specifics thereof, have been shown by way of example in the drawings and will be described in detail. It should be understood, however, that the intention is not to limit the claimed disclosures to the particular examples described. On the contrary, the intention is to cover all modifications, equivalents, and alternatives falling within the spirit and scope of the subject matter as defined by the claims.

### DETAILED DESCRIPTION

The present disclosure sets forth a faucet assembly with a side sprayer and an ozone production assembly. In operation, an ozone production assembly may receive a flow of non-ozonated fluid from a faucet assembly, selectively inject gaseous ozone into the received fluid, and supply a flow of ozonated fluid to a side sprayer. Alternatively, ozone may be directly generated in the fluid path, such as by electrolysis when the fluid is water, for example. In turn, a side sprayer may selectively dispense ozonated or non-ozonated fluid (depending on the selection of the user). Ozonated liquid may be used to kill bacteria in water and on surfaces when exposed to ozone for a period of time, such as, for example, 20 minutes. In one example, a flow of ozonated fluid may include an aqueous ozone concentration in a range of about 0.4-1.2 ppm. However, higher or lower concentrations may be used as well.

While an ozone production assembly may be manufactured alongside a faucet assembly, in some examples, an ozone production assembly may be retrofitted onto a pre-existing faucet assembly to allow for a dispersal of ozonated fluid. In the present disclosure, the term “pre-existing” means components manufactured, produced, or otherwise operational prior to being fluidically coupled to an ozone production assembly. For example, typically, pre-existing side sprayers receive a flow of non-ozonated fluid from a faucet assembly diverter or directly from a water supply line. However, in accordance with the present disclosure, rather than receiving a flow of non-ozonated fluid from a diverter, a pre-existing side sprayer may selectively receive a flow of ozonated fluid from an ozone production assembly. In turn, a side sprayer may selectively spray ozonated and non-ozonated fluid onto any desirable surface, e.g., basins, containers, food, dishes, etc.

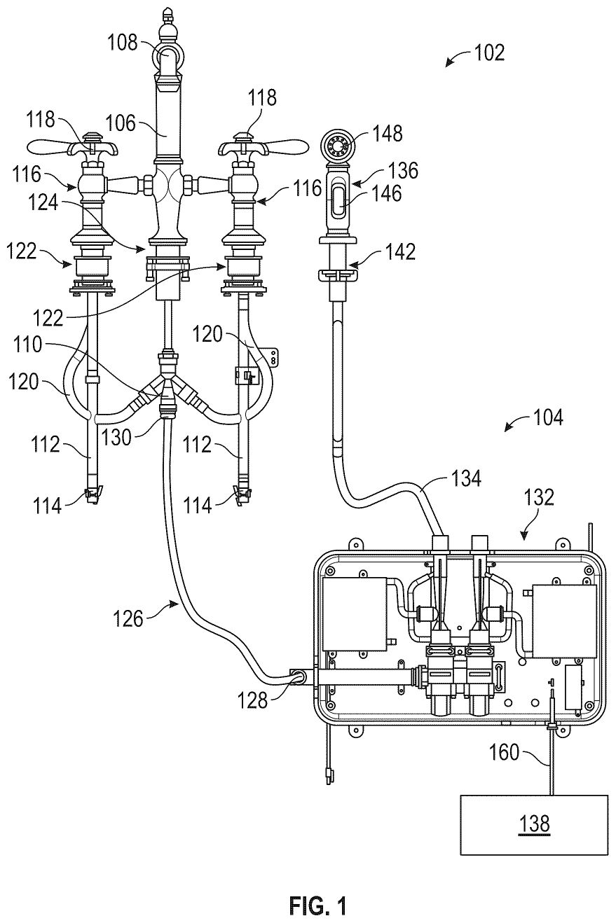

FIG. 1 is a perspective view of a faucet assembly fluidically coupled to an ozone production assembly, according to an example. Beginning with faucet assembly 102, it is to be understood that faucet assembly 102 may include any number of different components and configurations. For example, faucet assembly 102 may include Kohler Co.'s Artifacts™, Edalyn™, Components™, Graze™, etc. In one example, as shown, faucet assembly 102 may include a faucet 106 with internal fluid passageway(s) (not shown), mixing valve (not shown), and a spray head 108 with one or more nozzles (not shown) for dispensing liquid; a diverter 110 for regulating a fluid flow path; supply hoses 112 for receiving a flow of liquid from hot and cold liquid sources 114; handle assemblies 116 with levers 118, internal valve assemblies, and fluid passageways (not shown) for receiving and regulating fluid passage from supply hoses 112; outlet hoses 120 for fluidically coupling handle assemblies 116 to faucet 106; one or more coupling mechanisms 122 and 124 with washers, retainer rings, etc. for securing handle assemblies 116 and faucet 106, respectively, to a desired worksurface, e.g., kitchen surface; and a side sprayer 136 with a spray head 148, actuating mechanism 146, and spray hose 134 for carrying out a side spraying operation.

While multiple handle assemblies 116 with levers 118 are shown, in other examples, faucet assembly 102 may include a singular lever (not shown) disposed on faucet 106 with supply hoses 112 coupled directly to faucet 106. In operation, a singular lever may control a passage of liquid through faucet 106. Additional or fewer components may be used as well. For example, faucet 106 may include a motion sensor allowing for a motion activated spraying operation. In this example, faucet 106 may also include an outlet hose fluidically coupled to a flow sensor, solenoid valve assembly, and spray hose (not shown). In response to receiving an input signal from the motion sensor, a control system coupled to the motion sensor may generate a control signal for the solenoid valve allowing for fluid passage through the spray hose and, in turn, faucet 106. In accordance with the present disclosure, it is to be understood that faucet assembly 102 may take any number of different configurations with additional or fewer components.

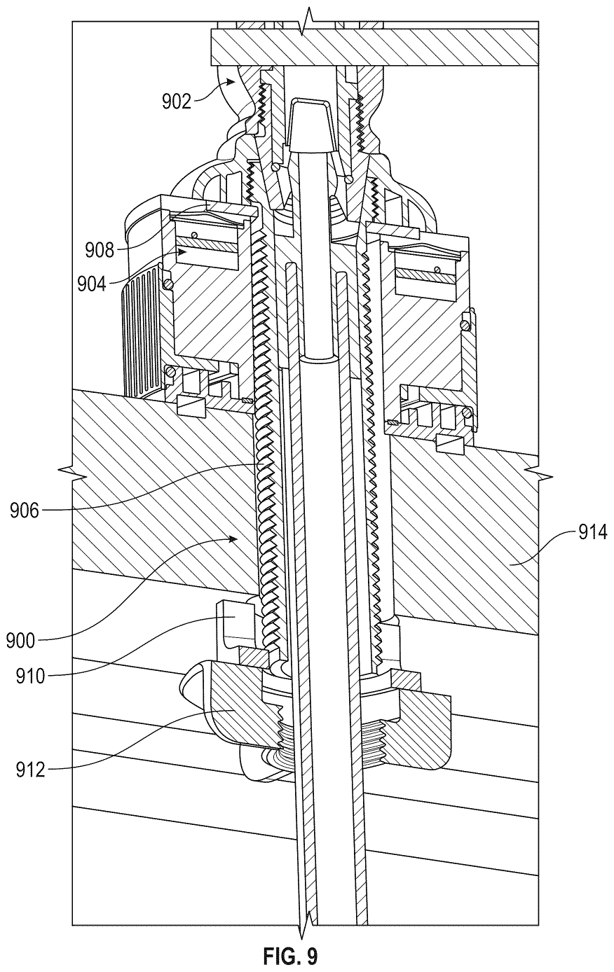

Turning to ozone production assembly 104, as shown, assembly 104 may include a supply hose 126 with first 128 and second ends 130 for supplying a flow of non-ozonated liquid to an inlet 129 of an ozone control unit 132; the control unit 132 for selectively injecting ozone into a flow of non-ozonated liquid; a coupling mechanism 142 for coupling a side sprayer, e.g., sprayer 136, to a desired worksite and a user interface device (see FIG. 9, below); and a power source 138 for supplying electrical power to control unit 132. In operation, control unit 132 may receive a flow of non-ozonated fluid from diverter 110 and supply hose 126, selectively inject ozone into the received fluid, and allow for ozonated and non-ozonated fluid dispersal through a side sprayer, e.g., sprayer 136. In one example, equal flow rates of ozonated and non-ozonated fluid may be provided.

Alternatively, control unit 132 may receive a flow of non-ozonated fluid from the cold water supply stop fitted with a tee fitting (not shown), in which one outlet of the tee directs water toward the faucet cold inlet or supply tube, and the other outlet of the tee directs water to inlet 129 of control unit 132, where ozone is selectively injected into the received fluid, and allow for ozonated and non-ozonated fluid dispersal through a side sprayer, e.g., sprayer 136. In yet another alternative example, in which no faucet is present, cold water supply 114 is coupled directly to the inlet 129 of control unit 132 where ozone is selectively injected into the received fluid, and allow for ozonated and non-ozonated fluid dispersal through a side sprayer, e.g., sprayer 136. In this configuration, sprayer 136 may have an internal valve capable of opening or shutting off the flow of water directly.

Power source 138 may include a class 2 power supply, 12V, maximum power outlet less than 100 watts, for supplying electrical power to one or more components of unit 132 through a power connector 160. Power connector 160 may be any suitable connector able to transfer electrical power from source 138 to unit 132.

Supply hose 126, as shown, includes first and second ends 130 and 128 for coupling to an outlet fitting of diverter 110 and an inlet of control unit 132, respectively. Hose 126 may comprise any number of different materials and suitable lengths for supplying non-ozonated fluid from diverter 110 to control unit 132. Further, depending on a type of diverter or valve assembly, first end 130 may include any number of different barbs for connecting hose 126 to a diverter outlet fitting. Second end 128 of hose 126 may include a ¼″ NPT male threaded plug configured to couple to an inlet, e.g., ¼″ NPT female piece, of control unit 132. However, other types of connectors may be used as well. For example, other such connectors may include mating connectors such as those used for standard faucets, or mating connectors having different hose connection geometries. Once coupled, a flow of non-ozonated liquid may pass from a diverter, through hose 126, and into control unit 132.

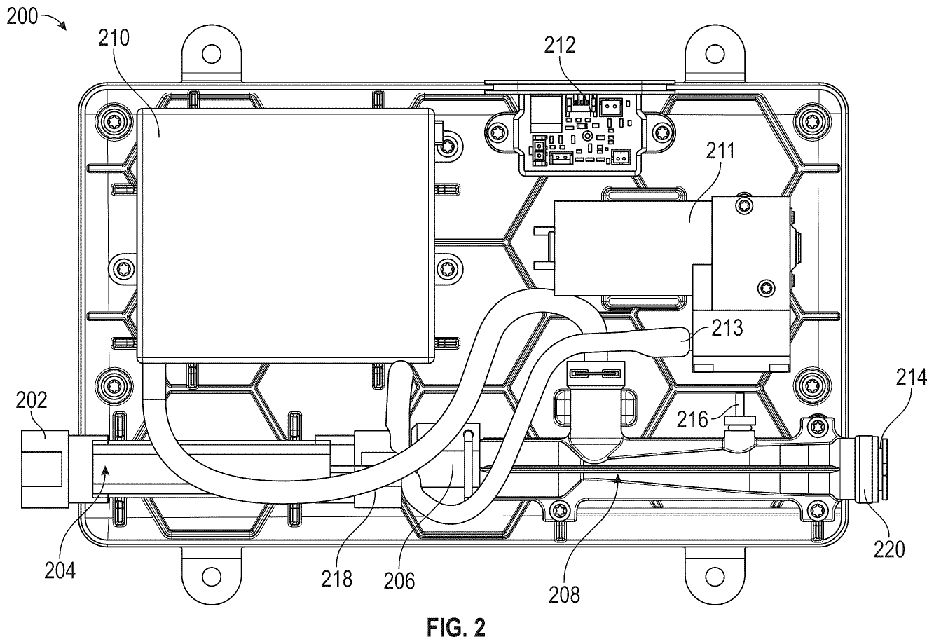

FIG. 2 illustratively shows a control unit of an ozone production assembly, according to an example. As shown, control unit 200 may include an ozone generator(s) 210 for producing ozone, such as gaseous ozone or alternatively, ozone generation by means of electrolysis in the flow path, a flow switch body 204 for monitoring a flow rate through unit 200, a sensor(s) 216, e.g., thermistor, for monitoring liquid flow characteristic(s), an injector body 208 for injecting ozone into a flow of liquid, a control circuit 212 for controlling operating parameters of unit 200, and a spray adapter 214 for coupling a spray hose, e.g., hose 134, to unit 200. In one example, control unit 200 may produce ozonated water between 0.05 and 0.1 ppm at a rate of 1.5-2.2 gallons per minute at 60 psi.

Ozone generator(s) 210 may include a Beyok FQT-300F, 12 VDC 9W. In this example, generator 210 may connect to an external air pump 211 and include a barbed hose connection 213. In one example of operation, generator 210 may produce ozone using corona discharge and output a maximum of 300-500 mg/hr of ozone when using oxygen as a feed gas. Other options for improving ozone generator performance include pairing an oxygen concentrator with the system and/or an air dryer to reduce the dew point of the air entering the generator. Ambient air without treatment will still create ozone, though at reduced concentrations.

In examples, other types of generators may be used as well. For example, pump 211 may be integrated into generator 210 itself, or situated anywhere before or after ozone generator 210, pulling a vacuum and drawing air into or pushing air through ozone generator 210. From there, the ozone would be injected into the flow path under positive pressure. When a system is combined with an air pump, it may be advantageous to inject the ozone gas into the fluid flow path at the throat of a venturi constriction (as shown), so as to reduce the requirements on pump output pressure. An example of a suitable pump for these configurations is a diaphragm pump.

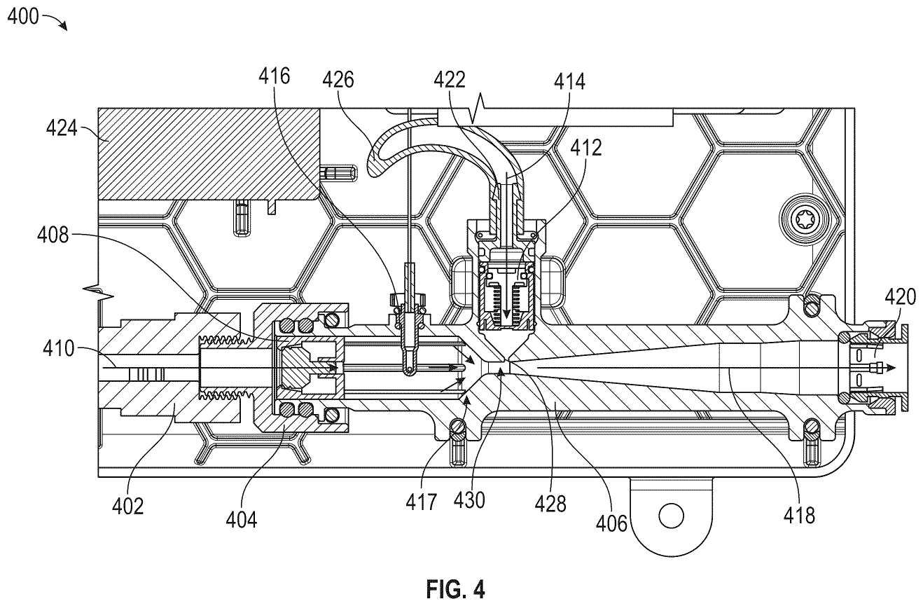

Flow switch body 204 may include an inlet 202, internal fluid passageway (not shown), and outlet 218 for receiving, monitoring, and supplying a flow of non-ozonated water from a supply hose, e.g., hose 126, to injector body 208. In some examples, flow switch body 204 may also be configured to be a flow meter (e. g, ultrasonic), with a signal read and interpreted by the control circuit which then determines if the fluid flow rate is above a set threshold. As discussed above, flow switch inlet 202 may include a ¼″ NPT female piece for coupling unit 200 to a supply hose, e.g., hose 126. Once coupled, a flow of non-ozonated fluid may pass into switch body 204 from a faucet assembly diverter, e.g., diverter 110. In turn, flow switch body 204 may monitor and supply a flow of non-ozonated fluid to injector body 208. Depending on a type of flow switch body 204 and injector body 208, any number of different adapters 206 with varying dimensions may be used to facilitate connection between switch body 204 and injector body 208. For example, as shown in FIG. 4, below, adapters 206 may include a national pipe thread (NPT) fitting with a threaded section for receiving a corresponding threaded portion of flow control outlet 218 of flow switch body and a bore (not shown) for interfacing with O-rings attached to injector body 208. A retention clip (not shown) is used to retain injector body 208, preventing the O-rings from separating. However, other adapters may be used as well, or can be omitted as a separate piece completely, being incorporated directly into injector body 208 or flow switch body 204. In yet another example, flow switch body 204 can be directly part of injector body 208, i.e. a single piece

As will be discussed further below in FIG. 4, injector body 208 may simultaneously receive a flow of non-ozonated water and ozone from switch body 204 and generator(s) 210, respectively, and passively inject ozone into the flow of non-ozonated water. In one example, injector(s) 208 may include venturi injector(s) that operate under the venturi effect to inject ozone into the non-ozonated fluid. Specifically, as shown in FIG. 4, below, injector body 208 may include a decreasing cross-sectional area that induces a pressure drop, increases flow rate, and suctions in ozone to a flow of non-ozonated fluid. Injector body 208 may optionally include a bypass channel (not shown), allowing a proportion of fluid flow to pass through a channel where gaseous ozone is injected and another portion of flow to pass through a separate channel, with both channels later recombining into a single unified channel, so as to more closely regulate venturi injector performance. Venturi injectors may be advantageous as they operate solely using fluid flow energy without necessitating external power sources and control systems. Alternatively, another example may rely on a pump, either entirely or in conjunction with a venturi injector.

Ozonated or non-ozonated fluid, may, in turn, pass through an injector outlet 220 and into a spray hose, e.g., hose 134, fluidically coupled to a side sprayer, e.g., sprayer 136. To facilitate connection between a pre-existing spray hose and injector outlet 220, adapter 214 may be used. Depending on a type of injector 208 and spray hose, e.g., hose 134, any number of adapters 214 with differing dimensions may be used. For example, adapter 214 may include a John Guest style quick connector, e.g., a push to connect ⅜″, ¼″, etc. configured to simultaneously couple to injector outlet 220 and a spray hose, e.g., hose 134. However, other adapters may be used as well.

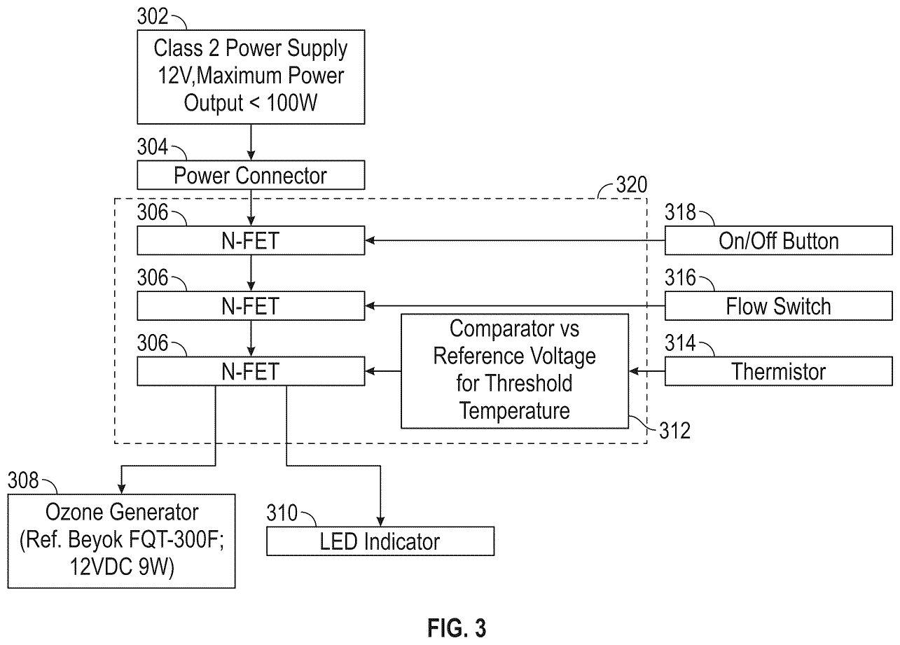

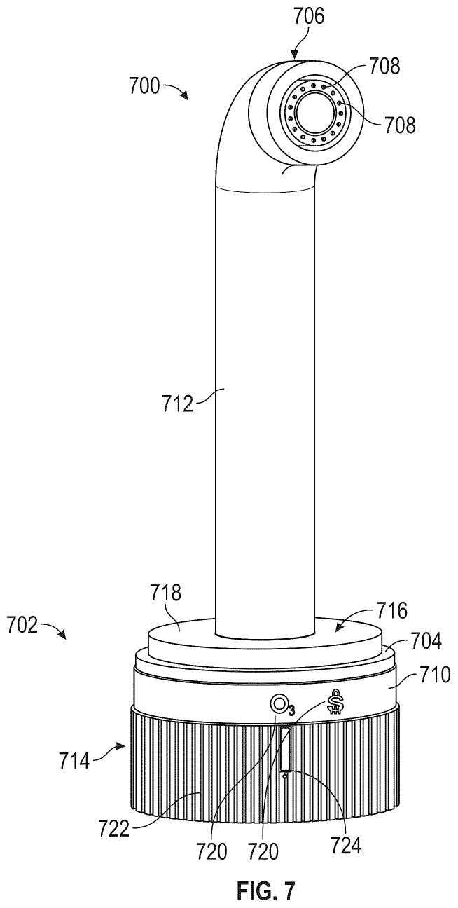

FIG. 3 illustratively shows a control circuit of an ozone production assembly, according to an example. In operation, a control circuit may control operation of a control unit, e.g., unit 200, and a production of ozone. As shown, a control circuit 320 may include a plurality of N-channel Field-Effect Transistors (N-FETs) 306 electrically coupled to an on/off button 318 of a user interface device, a flow switch 316, e.g., switch 204 or alternatively a flow meter, and comparator 312/thermistor 314. Comparator 312 may receive an output from thermistor 314 and compare the received output to a reference voltage to determine whether a temperature exceeds a threshold value. N-FETs 306 may utilize an electric field to control current flow. Namely, when a positive voltage is applied, an electrical field may be produced turning the N-FET on and allowing for current passage. In the absence of a positive voltage and electrical field, current passage may be prohibited. As a result, N-FETs may act as a switch and control operation of an ozone generator 308 and a LED indicator 310 on a user interface device. In operation, control circuit 300 may receive electrical power from a power source 302 via connector 304. As will be discussed further in FIG. 7, depending on received signals from button 318, switch 316, and comparator 312, N-FETs 306 may remain opened or closed to modify an operating parameter of ozone generator 308 and LED indicator 310. In this example, circuit 300 may operate without a microcontroller or firmware. However, in other examples, it is also contemplated that circuit 300 may include additional hardware devices, e.g., data storage devices, controllers, processors, communication systems, etc., and software for controlling operation of an ozone production assembly.

FIG. 4 illustratively shows an internal fluid flow path through a control unit, according to an example. As shown, a control unit 400 may include similar components to control units 132 and 200, e.g., a flow switch 402, adapters 404 and 420, ozone generator 424, sensor 416, injector 406, and tube 426. However, in this example, control unit 400 may further include a barbed fitting 422 and check valves 408 and 412. In operation, barbed fitting 422 may be placed within a top opening of injector 406 and effectively allow for fluid communication between generator 424 and injector 406. Check valves 408 and 412 may be used to permit unidirectional flow along flow paths 410 and 414, respectively. In accordance with the present disclosure, any number of different check valves and barbed fittings may be used.

As discussed above, in a first mode of operation, a flow of non-ozonated fluid may flow from a faucet assembly diverter, e.g., diverter 110, into flow switch 402 along path 410. In turn, the flow of non-ozonated fluid may through injector 406 along path 418. In a first mode of operation, ozone generator 424 may remain in an idle or off position such that only a flow of non-ozonated fluid is supplied to a downstream spray hose and side sprayer, e.g., hose 134 and sprayer 136. However, upon receiving a user input, a control circuit, e.g., circuit 212, may place unit 400 in a second operating mode in which ozone generator 424 is turned on or otherwise activated. Once active, generator 424 may generate and supply a flow of ozone through hose 426 along path 414. As discussed above, in one example, injector 406 may be a venturi injector that suctions in ozone through opening 428. Specifically, as shown, injector 406 may include a narrowing cross section or surface 416 and constriction 430 that serves to reduce fluid pressure and increase a fluid flow rate. As fluid passes through constriction 430, ozone may be passively suctioned into the non-ozonated fluid as fluid travels along path 418. In turn, ozonated fluid may pass through adapter 420 into a downstream spray hose and side sprayer. Depending on a received user input, a control circuit may alternate between operating modes in which non-ozonated and ozonated fluid is provided to a downstream side sprayer along a spray hose.

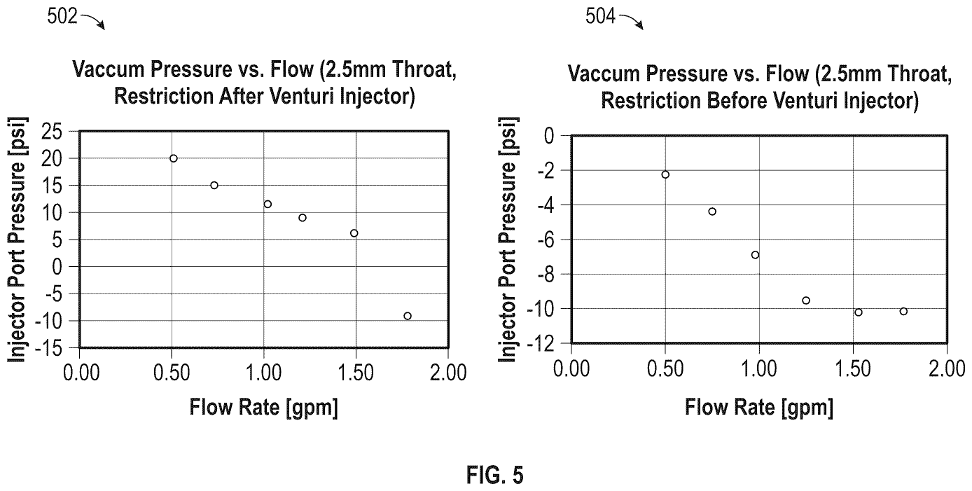

FIG. 5 illustratively and non-limiting shows restriction placement information for a venturi injector, according to an example, to demonstrate that the outlet restriction in a specific system may determine the necessity of a forced air injection system incorporating a pump or a passive injection system relying entirely on the suction generated by the venturi geometry and fluid flow.

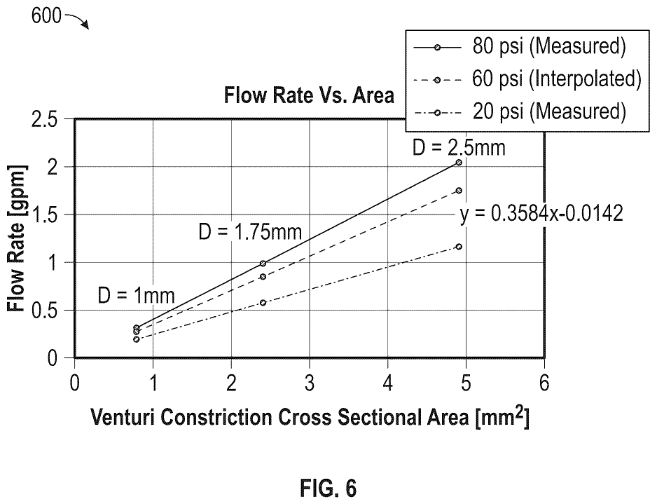

FIG. 6 illustratively and non-limiting shows cross sectional area information for a venturi injector, according to an example, to size the venturi injector to be able to achieve a desired flow rate, though the actual flow restriction is typically determined by the nozzles of the side spray assembly and hose attached to the outlet of the ozone control box assembly.

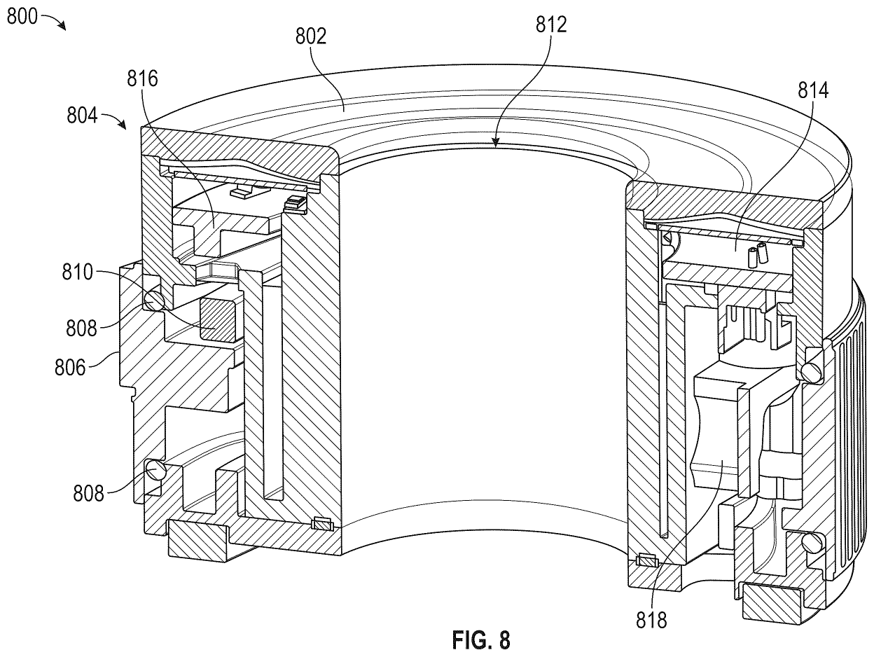

FIG. 7 illustratively shows a side sprayer and a user interface device of an ozone production assembly, according to an example. As noted above, it is to be understood that a side sprayer 700 may be manufactured as part of a pre-existing faucet assembly and retrofitted with an ozone production assembly or as an individual component for use with the same. For example, in some instances, a coupling mechanism 716 may be used to couple a pre-existing side sprayer to a user interface device as discussed in FIG. 8, below. However, in other examples, a pre-existing actuating mechanism on a side sprayer handle may be reconfigured to control operation of an ozone production assembly, such as, for example, a mechanical linkage such as a cable drive, electrical signals transmitted via wires embedded into the side spray hose, and a wireless transceiver embedded into the side spray assembly. Additionally, depending on a pre-existing faucet assembly, it is to be understood that various contemporary and traditional aesthetics may be chosen for a side sprayer and user interface device.

In operation, side sprayer 700 may receive a flow of ozonated or non-ozonated fluid from a control unit and dispense or otherwise spray ozonated or non-ozonated fluid. As shown, side sprayer 700 may include an elongated body 712 and spray head 706 with one or more internal fluid passageways (not shown) for supplying and dispensing a flow of ozonated or non-ozonated fluid through nozzle(s) 708. Nozzle(s) 708 may include any number or type of nozzles depending on a desired spraying operation or pre-existing faucet assembly. Depending on a type and orientation of nozzles 708, any number of different spray patterns may be observed.

A user interface device 702 may be used to control operation of an ozone production assembly, e.g., assembly 104 and, in turn, an ozone and non-ozone spraying operation. User interface device 702 may include a diffuser lens 704 for diffusing internal light, a body 710 with visual indicators 720 corresponding to different spraying operations, e.g., non-ozonated and ozonated spraying operations, and an actuating mechanism 714 for receiving a user input and modifying an operating parameter of an ozone production assembly, e.g., assembly 104, or faucet assembly, e.g., assembly 102.

For example, as shown, actuating mechanism 714 may include an outer rotating ring 722 with a protrusion 724 configured to align with visual indicators 720. As ring 722 rotates, an internal magnet (not shown) coupled to ring 722 may rotate to open or close one or more reed switches, or other magnetically actuated switch. Alternatively, a mechanical switch, optical switch, or similar switches can be utilized. In one non-limiting example, a single reed switch shifts between a closed state, and an open state that determines the behavior of corresponding control circuit, e.g., circuit 212 of FIG. 2, along an electrical connector. In turn, a control circuit may modify an operating parameter of an ozone production assembly, e.g., turning on or off an ozone generator, accordingly.

In some examples, actuating mechanism 714 may also allow for temperature and flow rate control through side sprayer 136. For example, mechanism 714 may couple to a faucet control (not shown) or control unit 132 and direct a temperature and flow rate through a diverter, e.g., diverter 110, control unit 132, and side sprayer 136. A liquid temperature may range from 40° F. to 110° F. In one example, a temperature control of a faucet assembly may have a nominally linear response through a range of adjustment. Further, it is contemplated that a non-ozonated fluid rate may be selected between 0 and 1.5 gpm and an ozonated fluid rate between 0.5 gpm and 1.5 gpm.

FIG. 8 illustratively shows an internal view of a user interface device, according to an example. Similar to device 702, user interface device 800 may include an actuating mechanism 804, a diffuser ring 802, and a rotating ring 806. Additionally, as shown, device 800 further includes a static PCB with a one or more reed switches 816 (or any of a variety of magnetically-, mechanically-, or optically-actuated switches) for each type of spraying operation, fully potted LEDs 814, an internal magnet 810 coupled to ring 806 for selectively opening and closing a reed switch, lubricated O-rings 808 for smooth rotation of ring 806, and a cable strain relief device 818 for alleviating electrical cable stress. As noted above, in operation, a user may rotate ring 806 to align an outer protrusion of ring 806 with a desired visual indicator corresponding to a desired spraying operation, e.g., ozonated, non-ozonated etc. Once aligned, magnet 810 may open or close a reed switch associated with the desired spraying operation. In turn, a signal may be provided along an electrical connector to a control circuit, e.g., circuit 212, to automatically modify an operating parameter in accordance with the received user input.

Light emitting diodes (LEDs) 814 may serve as visual indicators for ozonated and non-ozonated spraying operations. For example, when an ozone generator, e.g., generator 210, is actively producing ozone, LEDs 814 may be engaged to notify a user of such production. In one example, LEDs 814 may serve as a visual indicator no smaller than 0.25″ in diameter for notifying a user of an ozonated spraying operation.

FIG. 9 illustratively shows a coupling mechanism of an ozone production assembly, according to an example. As shown, a coupling mechanism 900 may include an escutcheon 908, a threaded shank 906 coupled to a side sprayer 902, a washer 910, and a threaded retainer ring 912. As briefly mentioned above, coupling mechanism 900 may be used to couple a pre-existing side sprayer 902 to a user interface device 904 and workspace 914, e.g., countertop. For example, escutcheon 908 may be placed on a top section of user interface device 904. After which, shank 906 may be coupled to a bottom of side sprayer 902 and inserted into a central opening of escutcheon 902, device 904, and workspace 914. In one example, a length of shank 906 may accommodate a variety of different pre-existing side sprayers 902. Specifically, suitable shank lengths arere dependent on the thickness of the counter plus an interface ring (if present. For example, a control ring may add about 1.5 inches to a standard shank length. Once through, washer 910 and threaded retainer 912 may securely fasten to shank 906 to securely couple side sprayer 902 to device 904 and worksurface 914. However, depending on a type of pre-existing side sprayer and respective ozone compatibility, it is contemplated that additional sealing devices may be used as well.

The disclosure may be embodied in other specific forms without departing from the essential attributes; therefore, the illustrated examples should be considered illustrative and not restrictive in all respects.

Various examples of systems, devices, and methods have been described herein. These examples are given only be way of example and are not intended to limit the scope of the claimed disclosures. It should be appreciated, moreover, that the various features of the examples that have been described may be combined in various ways to produce numerous additional examples. Moreover, while various material, dimensions, shapes, configurations, locations, etc. have been described for use with disclosed examples, others besides those disclosed may be utilized without exceeding the scope of the claimed disclosures.

Persons of ordinary skill in the relevant arts will recognize that the subject matter hereof may comprise fewer features than illustrated in any individual example described above. The examples described herein are not meant to be an exhaustive presentation of the ways in which the various features of the subject matter hereof may be combined. Accordingly, the examples are not mutually exclusive combinations of features; rather, the various examples can comprise a combination of different individual features selected from different individual examples, as understood be persons of ordinary skill in the art. Moreover, elements described with respect to one example can be implemented in other examples even when not described in such examples unless otherwise noted.

Any incorporation of reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a clam.

What is claimed is:

1. A side sprayer assembly comprising:
a side sprayer configured to dispense fluid therefrom; and
an ozone production assembly configured to introduce ozone into fluid for dispensing by the side sprayer, the ozone production assembly including a control unit with a control circuit, and an ozone generator for producing and supplying ozone to a flow of non-ozonated fluid for dispensing from the side sprayer.

2. The side sprayer of claim 1, wherein the control unit further comprises an injector, and a flow switch, wherein the flow switch is configured to monitor a flow of non-ozonated fluid from a supply house coupled to the control unit, and to supply the flow of non-ozonated fluid to the injector.

3. The side sprayer of claim 2, wherein the flow switch comprises a flow switch body including an inlet end coupled to the supply house, an internal fluid passageway, and an outlet end in fluid communication with the inlet end via the internal fluid passageway, wherein the outlet end is fluidly coupled to the injector.

4. The side sprayer of claim 3, wherein the injector comprises an injector body including an inlet end coupled to the outlet end of the flow switch body, an internal fluid passageway, and an outlet end in fluid communication with the inlet end via the internal fluid passageway, wherein the outlet end is fluidly coupled to the side sprayer via a hose.

5. The side sprayer of claim 2, wherein the injector comprises an venturi injector having a cross section that narrows along a portion thereof, and a constrictor configured to increase a fluid flow rate and reduce a fluid pressure, and
wherein the injector further comprises structure defining an opening at the constrictor, opening in fluid communication with the ozone generator such that when a non-ozonated fluid passes through the constrictor, ozone generated by the ozone generator is suctioned into the fluid and exits the injector to be dispensed as an ozonated fluid from the side sprayer.

6. The side sprayer of claim 1, wherein the control circuit is configured to alternate between a non-ozonated mode wherein the ozone generator is not activated and non-ozonated fluid is provided to the side sprayer, and an ozonated mode when the ozone generator is activated and ozonated fluid is provided to the side sprayer.

7. The side sprayer of claim 6, wherein the side sprayer comprises an elongated body, and spray head with one or more internal fluid passageways for supplying and dispensing a flow of ozonated or non-ozonated fluid through nozzles formed in the spray head.

8. The side sprayer of claim 6, wherein the side spray includes a user interface device to control operation of the ozone production assembly between the non-ozonated mode and the ozonated mode.

9. The side sprayer of claim 8, wherein the user interface device includes a diffuser lens for diffusing internal light, and a body with visual indicators corresponding to the non-ozonated mode and the ozonated mode, and an actuating mechanism for receiving a user input for selecting the non-ozonated mode or the ozonated mode, and/or an operating parameter of an ozone production assembly.

10. A faucet assembly with a side sprayer and ozone production assembly comprising:
a faucet configured to dispense fluid;
a side sprayer configured to dispense fluid;
a diverter for providing fluid from a fluid source to one of the faucet and the side sprayer;
an ozone production assembly configured to introduce ozone into fluid for dispensing by the side sprayer, the ozone production assembly including an ozone generator for producing and supplying ozone to a flow of non-ozonated fluid for dispensing from the side sprayer upon selection by a user; and
a user interface device coupled to the side sprayer to control operation of the ozone production assembly between an non-ozonated mode wherein the ozone generator is not activated and non-ozonated fluid is dispensed from the side spray, and an ozonated mode when the ozone generator is activated and ozonated fluid is provided to the side sprayer.

11. The faucet assembly of claim 10, wherein the user interface device includes a diffuser lens for diffusing internal light, a body with visual indicators corresponding to the non-ozonated mode and the ozonated mode, and an actuating mechanism configured to receive a user input for selecting the non-ozonated mode or the ozonated mode, and/or an operating parameter of an ozone production assembly.

12. The faucet assembly of claim 11, wherein the actuating mechanism comprises an outer rotating ring with a protrusion configured to align with the visual indicators.

13. The faucet assembly of claim 12, wherein the actuating mechanism is configured such that when the outer rotating ring rotates, an internal magnet coupled to ring rotates to open or close one or more switches to activate or deactivate the ozone generator.

14. The faucet assembly of claim 13, wherein the one or more switches comprises a reed switch.

15. The faucet assembly of claim 10, wherein the user interface device is further configured to control at least one of temperature and flow rate through the side sprayer.

16. The faucet assembly of claim 10, further comprising a coupling mechanism configured to couple the side sprayer to the user interface device and a supporting workspace.

17. The faucet assembly of claim 16, wherein the coupling mechanism includes an escutcheon coupled to a top surface of the user interface device, a threaded shank coupled to a bottom side of the side sprayer and extending through a central opening formed in each of the escutcheon, user interface device, and the workspace, and a washer and a threaded retainer ring coupled to an end of the threaded shank underneath the workspace to secure the side sprayer and user interface device to the workspace.

18. A method for converting a pre-existing side sprayer to an ozonated side sprayer assembly comprising:
providing a user input device, a coupling mechanism, and an ozone generator assembly;
coupling the ozone generator assembly at a first end to a fluid supply hose in fluid communication with a fluid supply, and a second end to a fluid supply hose in fluid communication with the side sprayer; and
coupling the user input device to the side sprayer and a workplace via the coupling mechanism.

19. The method of claim 18, wherein the coupling mechanism comprises an escutcheon, a threaded shank, a washer, and a threaded retainer ring, and wherein coupling the user input device to the side sprayer and a workplace comprises:
positioning the escutcheon on a top surface of the user interface device;
coupling a top end of the threaded shank to a bottom end of the side sprayer such that a fluid supply hose extends through a central opening of the threaded shank;
inserting the treaded shank into an opening formed in each of the escutcheon, user input device, and workplace;
positioning washer on a bottom end of the threaded shank; and
securing the retainer ring on the bottom end of the threaded shank to secure the user input device and the side sprayer to the workplace.

20. The method of claim 19, further comprising:
activating the ozone generator assembly by selecting an ozonated mode from the user input device, wherein ozone is generated by the ozone generator assembly and is injected into a fluid flow through the ozone generator assembly;
dispensing ozonated fluid through the side sprayer; and
deactivating the ozone generator assembly by selecting a non-ozonated mode from the user input device.
